(19) United States
(12) Patent Application Publication
(10) Pub. No.: US 2008/0195632 A1
(43) Pub. Date: Aug. 14, 2008

(54) METHOD FOR COMPOSING A RESOURCE LOCATOR ADDRESS, CORRESPONDING DEVICE AND COMPUTER PROGRAM PRODUCT

(75) Inventors: Jean-Pierre Le Rouzic, Rennes (FR); Christian Barre, Betton (FR)

Correspondence Address: WESTMAN CHAMPLIN & KELLY, P.A., SUITE 1400, 900 SECOND AVENUE SOUTH, MINNEAPOLIS, MN, 55402-3244, US

(73) Assignee: France Telecom, Paris (FR)

(21) Appl. No.: 12/028,367

(22) Filed: Feb. 8, 2008

(30) Foreign Application Priority Data
Feb. 8, 2007 (FR) 07/00907

(51) Int. Cl. G06F 17/30

(52) U.S. Cl. 707/10; 707/E17.112

(57) ABSTRACT

A method is provided for composing an address for locating a resource on the Internet. The method includes a phase of conversion of a piece of data into a locator address. The phase of conversion includes a step for the entry by a user, into a browser software, of a piece of data representing a locator address; a step for comparing the piece of entered data with at least certain of the addresses of a plurality of preliminarily validated locator addresses indicating whether the entered data is present in the plurality of addresses; and a step for selecting a locating address from among the addresses of the plurality of addresses.

### CROSS-REFERENCE TO RELATED APPLICATION

None.

### FIELD OF THE DISCLOSURE

The present disclosure relates to the field of browser software on Internet type backbone networks and more particularly to the composing of a resource locator address within such backbone networks.

### BACKGROUND OF THE DISCLOSURE

1. Prior Art

In order to access resources on the Internet, a user has several possibilities available to him. In a first approach, he can directly enter the address of the resource that he wishes to view within the browser that he is using. Such an entry is done by means of an entry zone set apart for this purpose in the Internet browser software. The user therefore copies an address into this zone which he has noted beforehand or recorded within this terminal. Once this entry has been made, the navigation software tries to access the resource in linking up to a server.

When a user is in the habit of consulting a site regularly, he can record addresses in a set of bookmarks. These bookmarks enable the user to avoid having to re-enter the same addresses several times and, enables the address to be entered in the address entry zone with a few mouse clicks.

Another method of accessing resources consists in searching for information by keywords using a server specifically designed for this purpose. The server enters words and expressions for which he wishes to obtain a set of sites or pages containing the keywords entered. Then, in liaison with databases, the search engine takes charge of the search for resources that correspond to the words or expressions entered by the user. Once this search has been made, the search server presents the user with a set of results corresponding to his criteria. This set of results comprises a list of resources accessible by means of links. These links can be clicked on, i.e. the user can access the resource by a simple mouse click on the link, thus avoiding the necessity of entering the access address giving access to the resource directly in the browser.

An access method of this kind is also possible directly from resources to which the user obtains access. Indeed, the general principle of the Internet consists in proposing links through pages consulted in the browsers in order to enable users to access new resources without having to enter a new address each time.

2. Drawbacks of the Prior Art

One drawback of these prior-art techniques of access to resources is related to the format of the locating addresses. For, such addresses are often difficult to memorize. In order to overcome this drawback, most present-day browsers record a history of the addresses composed or keyed-in by the user. Such a history is proposed to the user within a scrolling list when he starts entering an address in an entry zone set apart for this purpose. The addresses previously entered by the user that correspond to the start of the address being entered are presented so that the user can select the address that he wishes to select.

Such a technique however does not resolve the drawbacks related to the complexity of the addresses. Indeed, most of the users do not know the formats of the addresses. It is therefore easy to mistake one address for another. Thus, for example, an unsuspecting user will easily be confused between the addresses “www.myshop.com” and “www.my.shop.com”. Now this difference, even if scanty, is significant. Indeed, the first address may, for example, give access to a site having lawfully possessed personal information, for example through a merchant selling articles on the network. The second address for its part may belong to a criminal organization whose aim is to retrieve such personal information without the user's knowledge by making him believe that the is actually on the site of the merchant having the first address. This technique is generally called “phishing” (a shrinking word formed by the words “fishing” and “phreaking”, i.e. telephone-line piracy).

Thus, a user who implements prior-art techniques for keying in addresses is never really sure of what he is going to get.

To overcome this drawback, secure communications solutions have been set up, entailing especially the exchange of certificates between the servers and the browser by means of trusted third parties. Such solutions may prove to be adequate when the security policy of the servers or of the trusted third parties is regularly monitored. However, in most cases, such policies do not exist or are not managed sufficiently well managed.

Thus, many Internet sites which set up security policies based on certificates, based especially on the secured HTTPS protocol (which is a secured version of HTTP) do not renew their certificates regularly. This generally prompts the appearance of a warning dialog box when a resource is accessed, to the effect that the certificate has expired. Over time, this dialog box whose initial goal had been to warn users of potential risks, has becomes a guarantee of security for these users. The purpose of this warning has therefore completely lost its meaning since the users believe themselves to be well protected when they identify a warning dialog box of this kind.

Consequently, it can clearly be seen that present-day techniques do not enable users to be sure either of the veracity of the contents available through resource locator addresses or of the authenticity of the server to which they wish to obtain access.

### SUMMARY

The solution proposed by an aspect of the present disclosure can be used to overcome these prior-art drawbacks through a method for keying in a resource locator address on the Internet.

According to an aspect of the disclosure, a method of this kind comprises a phase of conversion of a piece of data into a locator address comprising:
a step for the entry by a user, into a browser software, of a piece of data representing a locator address;
a step for comparing said piece of entered data with at least certain of the addresses of a plurality of preliminarily validated locator addresses indicating whether said entered data is present in said plurality of addresses;
a step for selecting a locating address from among the addresses of said plurality of addresses.

Thus, unlike in the prior art techniques, the present disclosure makes it possible to validate the address entries that have been made by the users. Indeed, the prior art composing techniques are limited to presenting the user with a set of addresses, for example in the form of a scrolling list, pre-entered by the user without any validation whatsoever of these addresses. The validation is aimed at guaranteeing that an address belonging to the list of validated addresses can be selected without risk. The prior-art composing techniques therefore cannot be used to ensure the validity of the address (URL). Thus, if a user makes a mistake, for example when entering an address or again if this address sends him to a wrong site, the prior art techniques are incapable of protecting this user or at least of alerting him to this fact. The method provides this protection by a validation of the locator address in order to provide a list of locator addresses called validated addresses which a user is authorized to access.

An aspect of the disclosure therefore makes it possible to take account of problems of entering (or transferring as parameters) not only addresses as such but also any piece of data entered into the browser or browser software. Thus, the pieces of data entered by the user, for example within an address entry bar, are compared with a plurality of validated addresses (a set of addresses) so as to enable the browser to reach a determined address from among the plurality of addresses. Thus, a sharp distinction is obtained with respect to the prior-art techniques which, during the entry of a piece of information into the address bar of the browser, are limited either to displaying the page corresponding to the address if the entered data is effectively a URL or to displaying an error page.

According to an original embodiment, said conversion phase comprises:
a step of preliminary connection with an address management server;
a step for the updating, within the browser software, of at least one data base of locator addresses, validated from said server.

Thus, the invention is not limited by the number of addresses validated. Indeed, in ensuring the possibility of a connection with the validated-address management server, the method makes it possible to take account of the progress, both of the number of addresses available on the Internet and of the incessant changes in addresses that a great many sites undergo everyday.

According to a particular embodiment, said step for selecting said locator address comprises:
a sub-step for checking the compliance of said piece of entered data as a function of a grammar, delivering a piece of information on compliance of the entry;
a sub-step for qualifying said piece of entered data according to said piece of information on compliance, delivering a type of said piece of entered information;
a sub-step for processing said piece of entered data as a function of said piece of information on compliance and of said type.

Thus, an aspect of the disclosure is used to make sure of the integrity of the pieces of data entered by the user in checking their compliance. The method thus makes it very difficult to hack into information entered by the user by integrating the checking and qualification of the data to enable its processing.

According to a particular characteristic, said processing sub-step comprises, when said type identifies said piece of entered data as being a locator address:
a sub-step for making a search, within said address data base, for a correspondence between said entered data and a set of locator addresses; and
a sub-step for examining said piece of entered data when no correspondence has been identified;
a sub-step for the selection of said locator address when a correspondence has been identified.

Thus, an aspect of the disclosure is used to make sure of the validity of the piece of data entered, within the browser or within the Internet communications software, and that the inspection of the address is carried out by emphasizing the search for correspondence within the address data base. When a correspondence can be set up, the method selects the address available within the address list. Thus, an address that has been wrongly entered involuntarily will get corrected by the method. When no correspondence can be made, the address entered by the user undergoes an examination phase.

According to a particular characteristic, said examination sub-step comprises:
a sub-step for testing said resource locator address delivering a piece of information on dangerousness;
a warning sub-step requesting said user to confirm access to data coming from said resource locator address as a function of said information on danger; and
a sub-step for adding said resource locator address to said plurality of addresses when said user confirms said access.

Thus, an aspect of the present disclosure provides a mechanism to ensure that an address to which access is required poses no danger to the user or the program that asks for it. Indeed, prior to any validation by the user, the method permits a testing of this address to verify the dangerousness of the data given, this test being done for example through an access by a server to the resources identified by the address. This information on dangerousness can then be presented to the user or to the program who or which decides whether to continue the access procedure. In such a case, this new address is added to the set of existing addresses.

According to an original embodiment, said processing sub-step comprises, when said type identifies said piece of entered information as not being a locator address:
a sub-step for the selection, within said address data base, of at least one locator address corresponding to said information entered as a function of at least one predetermined selection parameter.

Thus, during the entry or passage of a parameter, the method makes it possible, for example by techniques for associating keywords or other relevant mechanisms set up within the rules engine, to associate at least one address with the piece of data. Such an address is considered to be secure because it forms part of the set of validated addresses.

The disclosure also relates to a device for composing an address for locating a resource on the Internet.

Such a device comprises means for converting a piece of data entered into a locator address, these means comprising:
means of entry, by a user, of said piece of entered data representing a locator address into a browser software program;
means for comparing said piece of entered data with at least certain of the addresses of a plurality of preliminarily validated locator addresses indicating whether said entered data is present in said plurality of addresses;
means for selecting a locating address from among the addresses of said plurality of addresses.

In another embodiment the disclosure also relates to a computer program product downloadable from a communications network and/or stored on a computer readable carrier and/or executable by a microprocessor.

According to the disclosure, at least one embodiment of such a computer program product comprises program code instructions to execute the composing method as described here above.

### BRIEF DESCRIPTION OF THE DRAWINGS

Other features and advantages shall appear more clearly from the following description, given by way of a simple and non-restricted illustrative example and from the appended drawings, of which:

FIG. 1 is a block diagram of a browser software program;

FIG. 2 is a schematic illustration of the address composition method implemented within a browser software program of FIG. 1;

FIG. 3 gives a more precise description of the interactions between a customer and a server during the implementation of the method;

FIG. 4 provides a detailed view of an embodiment of the composing method;

FIG. 5 provides a schematic view of an address composing device.

### DETAILED DESCRIPTION OF ILLUSTRATIVE EMBODIMENTS

The Internet enables each and everyone to access very large amounts of information by means of browser software programs. Such software programs permit data from servers to be loaded into a user terminal and displayed therein.

This data can be accessed by means of resource locator addresses commonly called addresses or locator addresses or URLs (Uniform Resource Locator) or again URIs (Uniform Resource Identifier) and addresses that identify the sources by their names or URN (Uniform Resource Names). Here below in this document, no distinction is made between the different terms, and reference shall be made to addresses, locator addresses or resource locator addresses without any distinction between them.

An address therefore enables a browser software program or any other program to reach a given server (also called a web server) and obtain a set of data from this server. The data is displayed by the browser, or taken into account by the software program. These uniform resources (URL, URN and URI) comply with the universal naming format used to designate a resource on the Internet. A URL may be represented in the form of a string of characters which can be broken down into several parts comprising:
an identification of the protocol, namely the language used to communicate on the network such as the HTTP (Hypertext Transfer Protocol);
a domain name of a server which hosts the resource to which access is requested. In certain cases this domain name can be replaced by the IP (Internet Protocol) address of the server;
an access path to the resource enabling the server to identify the location within which the resource is situated, i.e. in general a directory or a file name.

The URL is therefore a means of universal access to information on the network but its mode of operation is not known to the large majority of users of browser software.

### 1 Reminder of General Principles

An aspect of the disclosure proposes to compose the resource locator addresses in place of a user in order to ensure that these addresses are sure. The approach of the present disclosure makes it possible to take account of the security aspects of the entry and validation of the resource locator addresses in a simple way, without requiring the establishment of complex and costly security architectures. The general principle of the disclosure relies on the selection of one locator address among the addresses of a plurality of pre-validated addresses. The disclosure thus provides a novel and inventive solution to the problem of security induced by the manual or semi-automatic entry of addresses in browsers. An aspect of the disclosure relies on the following technical elements:
an Internet customer software capable of accessing resources present in servers that may or may not be remote, in the form of URLs and taking, for example, the form of an Internet browser (compliant with the standards governing software programs of this type) and possessing a zone for the insertion of a resource locator address. This address is in text form;
a set of authorized addresses. This set may be local or remote, situated on a trusted server. If the set of addresses is situated on a remote server, a cache may possibly be held locally within the browser. The function of such a cache is that it enables the search for an address within the cache rather than remotely;
rules for the interpretation of the addresses, which enable the different compositions of the addresses entered by the user to be taken into account;
security elements ensuring, for example, the functions of authentication of a remote server that possesses the set of validated addresses.

Here below we shall present especially the case of an implementation of the composing method according to the present disclosure in the context of a browser that incorporates its own set of addresses in the form of a cache. It is clear however that the disclosure is not limited to this particular application but can also be implemented in many other fields, and for example in the case of a base of validated addresses situated for example in a local network or a residential digital terminal or more generally in all cases where the listed advantages are of interest.

### 2. Description of an Embodiment

The description of this embodiment presents the implementation of a composing method according to the disclosure, in the context of a browser that incorporates its own set of addresses, for example in the form of a cache, a data base or a directory.

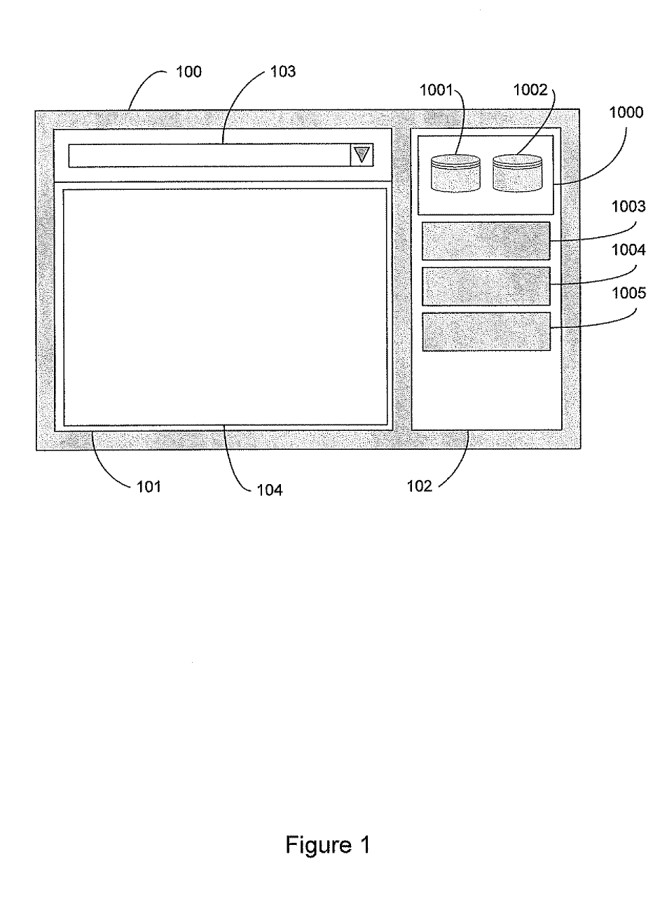

FIG. 1 is a schematic view of a browser implementing the composing method according to the disclosure. A browser 100 is broadly speaking constituted by a user interface 101 and a set of software components 102 enabling especially access to the Internet, access to resources and the display and rendering of data presented within the web server.

The user interface 101 consists of an address entry zone 103 which may take the form of a scrolling list. It also has a rendering or display zone 104 within which the software components restitute the data accessible at resources available at the address entered in the address entry zone 103. According to a particular embodiment, the software components 102 of the browser furthermore comprise:
for example, a data base 1000 called an “address list”. It may also be a directory or any other means of storage of a list. This address list consists of two sub-sets:
   a “principal directory” 1001 corresponding to the validated (reliable) addresses which are for example sent by a server;
   a “personal directory” 1002 corresponding to the place of storage of addresses that the user considers to be sure;
a rules engine 1003 receiving for example rules from one of the sure servers and storing them in a base of address interpretation rules 1004;
a manager of security elements 1005 enabling authentic connections to be set up with a server (in the form of security instruments).

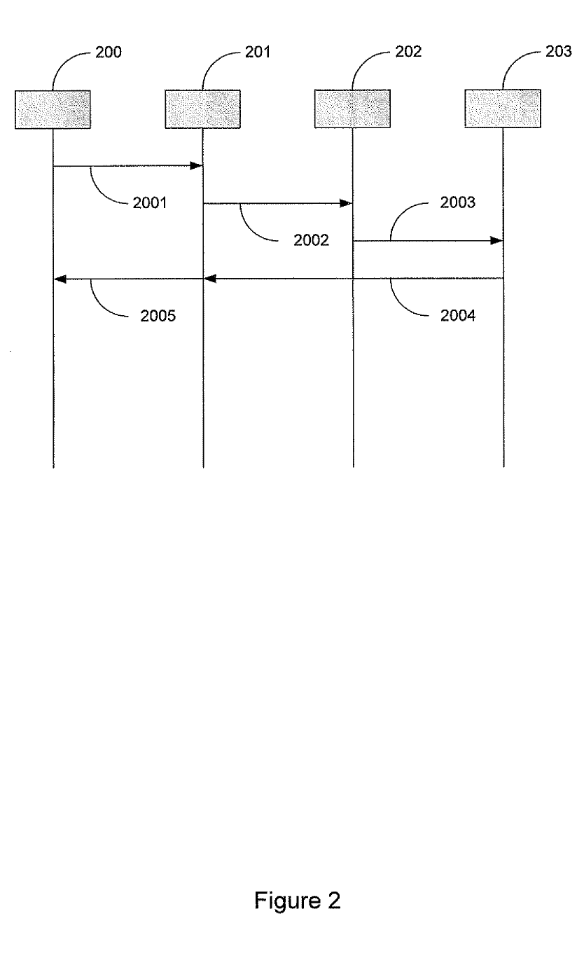

FIG. 2 is a diagram of sequences presenting the different general steps of this embodiment of the method.

A user 200 enters (2001) a locator address within his browser 201. This browser 201 analyses and verifies (2002) the validity of the address (validation phase) entered by means of the modules 202 (described above in FIG. 1) contained in the browser. If the address entered by the user is validated, the modules 202 authorize (2003) the browser 201 to contact the server 203 which has the resource at its disposal. This server 203 sends (2004) the resource composition data back to the browser 201 which displays them (2005) so that the user can view them.

### 3. Description of a Particular Embodiment

When a user starts composing his text in the address bar of the browser, for example as soon as he makes the first click in this zone, the address handling engine (rules engine) interprets the address handling rules according to the information elements given by the user. Thus:
when the user starts keying in an expression in which the syntax is fixed, for example “http://www.” or “www.”, then this zone can be inserted automatically depending on the subsequent information elements (corresponding to the variable part of the address) given by the user. For example, if he continues the keying-in process in indicating “mysho”, the rules engine will identify, amongst several possibilities, the address “www.myshop.com” which is part of the validated addresses;
when the user starts keying in an expression in which the syntax is free, the content keyed in by the user is interpreted by the address handling engine according to rules defined in the rules engine. For example, if the user has started typing “shop”, then the rules handling engine proposes “www.myshop.com” as well as other values which have meaning in relation to this keyed-in text. In another example, if the user has composed “flo” for “flowers”, it may be useful to propose “www.myshop.com”.

Thus, the different cases of management of expressions entered by the user are:
automatic completing by the validated addresses of the set of validated addresses;
automatic completing according to an entry in natural language, presenting a list of validated addresses chosen from among the addresses validated relative to the interpretation of the entry;
entry by the user of a URL that is well formed but unknown.

In the last-named case, if the user wishes to add an address, then a remote server is called upon. This remote server will examine the URL in the form of a test of the address in question in order to verify the dangerousness of the data that will be sent back by the resource (dangerousness in the form of phishing, presence of malware, injection of script, etc.). Depending on this server's response, a message can be displayed for the user who can then decide whether or not to incorporate this new URL into his personal validated data base in a local directory for example.

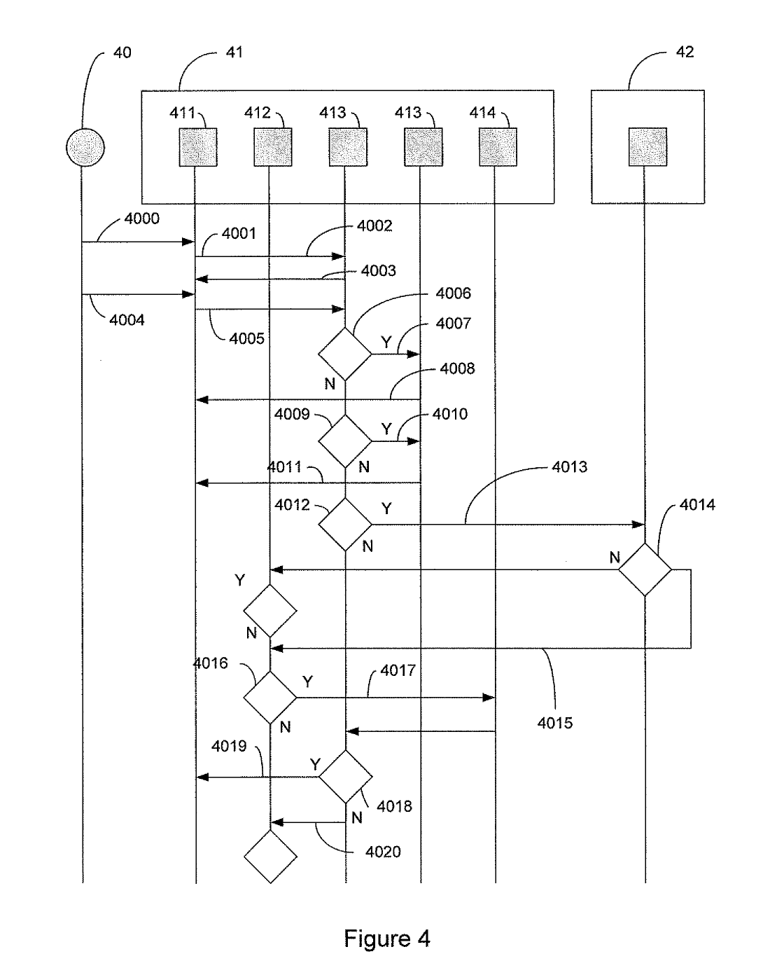

Referring to FIG. 4, we present a detailed description of an embodiment of the composing method:
a user 40 clicks (4000) on the address bar 411 of his browser 41 or an external program 40 launches a browser 41 with a URL as a parameter;
the address bar 411 asks (4001) the rules engine 413 what the obligatory items of information are. This phase is optional, for example if the browser has been launched by an external program;
the rules motor 413 provides (4003) the obligatory elements. This phase is optional, for example if the browser has been launched by an external program;
the user 40 composes (4004) the remainder of his text. This phase is optional if the browser has been launched by an external program;
the complete URL, i.e. complete, from the viewpoint of the final user or in the case of launching by an external program, is sent (4005) to the rules engine 413;
the rules engine 413 determines (4006) if the URL is incomplete;
   if it is incomplete, the rules engine 413 makes a request to the main URL directory 413:
      should only one URL be found, the main directory 414 sends (4008) the completed URL. The search for completion can be done by means of regular expressions or another means. The result is sent to the address bar 411;
      should an address list be found, there is automatic composition depending on the user's choice;
   if it is expressed in a way that is not compatible with the syntax of a URL (4009), then it may be a request made in natural language (4010):
      the usual search techniques may be used here. For example, a search can be made from keywords which are isolated in the request. Another possibility that may be used in combination is that of deeming the isolated keywords to be logically attached to sets of words (ontologies). The history of the searches made by the user can also be exploited to set up a list of keywords. In any case, the base on which the search is made consists of the main address directory 414 to the exclusion of any other base. This point can ensure high browsing security;
      the techniques of analysis of the natural language may also be used, for example there may be analysis in interwoven layers (lexical, syntactic, semantic, and pragmatic analyses);
      the main directory 414 sends (4011) the address found at the address bar 411;
      when a previous list of addresses has been found, there is automatic composition depending on the user's choice;
if the URL is complete (4012) but the search in the directory reports nothing, then it may be a legitimate address but one that is relatively personal to the user. It is therefore proposed to add it to the personal address directory but first of all its harmlessness needs to be tested. To this end, the URL is sent (4013) to the server 42;
the server will make a test (4014) of this harmlessness or dangerousness. The test consists in making a query on the URL in question:
   the URL may not correspond to what it seems to be (4015), for example it may highlight a domain name but send a link to another site (www.myshop.false.fr); another example consists in using HTML to create the impression that this is a valid URL whereas the URL is from a malicious site (the user clicks on a link which appears as www.myshop.com but in fact corresponds to 234.88.456.94/fake_myshop);
   the URL may link up to a site containing malicious code, for example it may contain Flash code which would activate the microphone of the webcam without the user's knowledge. It may also contain unsigned “ActiveX” type programs, and other potentially dangerous codes;
   the URL may enable attacks by cross-scripting or theft of credentials (this is the case where a personal page is in the same domain name as the administration part of the site);
   it may also happen that the site is very poorly protected without being malicious (no DMZ, CGI/ASP/Java code accessible on line);
the result is presented to the user in a special window 412; if the user persists in his decision (4016), the URL will be added (4017) to the list of personal addresses 415;
the next check (4018) consists in testing the parameters of the URL. Indeed, the parameters of a valid address may also constitute a danger. It is the rules engine 413 that takes charge of this work:
   this may be done by detecting the “strange” characters located in the parameters for example <>) which could indicate “cross-scripting ( . . . );
   this can also be done in verifying that non-anonymized identifiers are not sent;
if the address seems to be harmless, the result is presented (4019) to the user who decides on subsequent action;
if not, a special window 412 is used to warn (4020) the user of the dangerousness of the address.

### 4. Management of Sets of Addresses and Rules

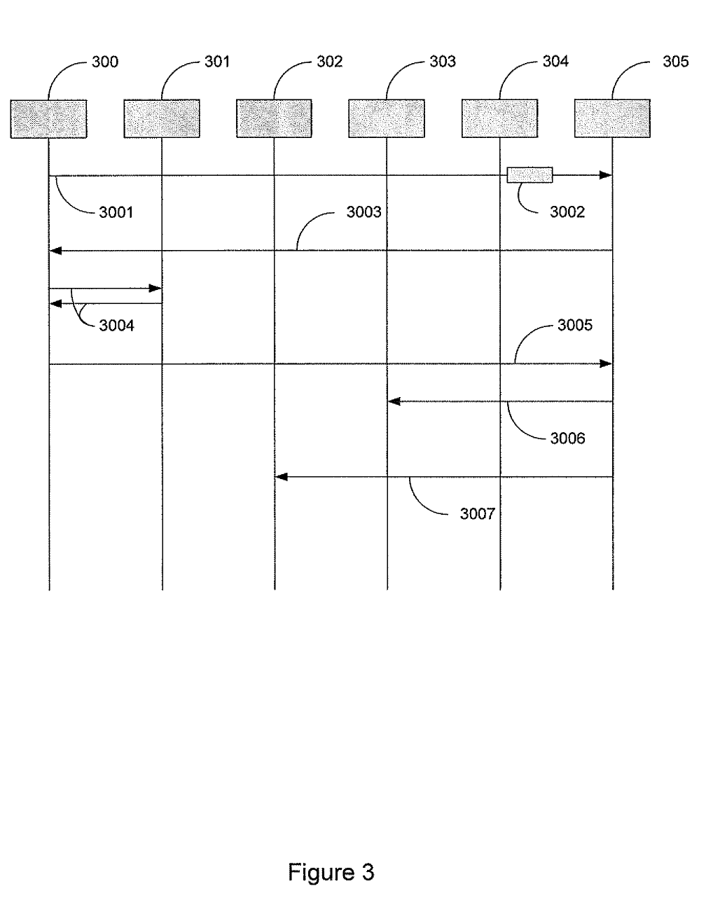

Referring to FIG. 3, we present an embodiment of the composing method, prior to the verification step, the browser enters into contact with a server in a secured way so that the server can send him an up-to-date validated address list.

The browser 300 links up (3001) to a server for the management of sets of validated addresses 305, in attaching a piece of information to its connection data. This piece of information represents an identifier (3002) of a set of validated addresses 303 and/or a base of address interpretation rules (302) pre-installed in the browser. In one alternative embodiment, the server can also manage the identification of the sets of addresses installed with users without any need for the browsers to transfer an identifier.

When the set of addresses 303 installed in the browser is not up to date, the server 305 requests (3003) the browser 300 to set up a connection in order to load a new set. The browser 301 then carries out a check (3004) on the identity of the server 305 using authentication instruments 301 (also called credentials). When this verification leads to the authentication of the server 305, the browser 300 asks (3005) the server 305 to send it the address or set of addresses and rules to be updated. The server 305 then updates (3006, 3007) the set of validated addresses 303 and/or the set of address interpretation rules 302.

### 5. Schematic Presentation of a Composing Device

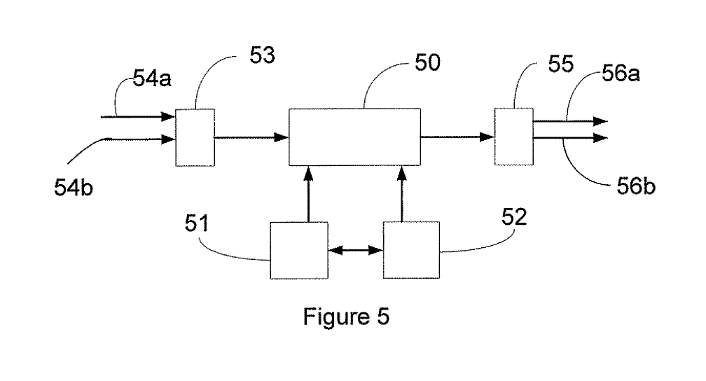

Referring to FIG. 5, we present an address composing device.

It comprises a memory 51 and a processing unit 50 equipped with a microprocessor driven by a computer program (or application) 52. The processing unit 50 receives the following at input through an input interface module 53:
entries or parameters coming from users or third party software 24a;
data concerning the sets of validated addresses and the rules of interpretation coming from the software 24b.

This information is processed by the microprocessor according to the instructions of the program 20 in order to:
validate and present their entered and/or sought addresses 26a;
send (26b) commands intended for the server.

This data is transmitted through an output interface module 25 to the modules which are in charge of them.

Although the present disclosure has been described with reference to one or more examples, workers skilled in the art will recognize that changes may be made in form and detail without departing from the scope of the disclosure and/or appended claims.

What is claimed is:

1. Method for composing an address for locating a resource on the Internet, wherein the method comprises a phase of conversion of a piece of data into a locator address comprising:
entry by a user, into a browser software, of a piece of data representing a locator address;
comparing said piece of entered data with at least certain addresses of a plurality of preliminarily validated locator addresses indicating whether said entered data is present in said plurality of addresses; and
selecting a locator address from among the addresses of said plurality of addresses.

2. Composing method according to claim 1, wherein said conversion phase comprises:
preliminarily connecting with an address management server; and
updating, within the browser software, of at least one data base of locator addresses, validated from said server.

3. Composing method according to claim 1, wherein said of selecting said locator address comprises:
a sub-step of checking compliance of said piece of entered data as a function of a grammar, delivering a piece of information on compliance of the entry;
a sub-step of qualifying said piece of entered data as a function of said piece of information on compliance, delivering a type of said piece of entered information; and
a sub-step of processing said piece of entered data as a function of said piece of information on compliance and of said type.

4. Composing method according to claim 3, wherein said processing sub-step comprises the following when said type identifies said piece of entered data as being a locator address:
a sub-step of making a search, within said address data base, for a correspondence between said piece of entered data and a set of locator addresses; and
a sub-step of examining said piece of entered data when no correspondence has been identified;
a sub-step of selecting said locator address when a correspondence has been identified.

5. Composing method according to claim 4, wherein said examining sub-step comprises:
a sub-step of testing said resource locator address delivering a piece of information on dangerousness;
a warning sub-step requesting said user to confirm access to data coming from said resource locator address as a function of said piece of information on dangerousness; and
a sub-step of adding said resource locator address to said plurality of addresses when said user confirms said access.

6. Composing method according to claim 3, wherein said processing sub-step comprises the following when said type identifies said piece of entered information as not being a locator address:
a sub-step of selecting, within said address data base, at least one locator address corresponding to said piece of entered information as a function of at least one predetermined selection parameter.

7. Device for composing an address for locating a resource on the Internet, wherein the device comprises means for converting a piece of entered data into a locator address, the means for converting comprising:
means of entry, by a user, of said piece of entered data representing a locator address into a browser software program;
means for comparing said piece of entered data with at least certain of the addresses of a plurality of preliminarily validated locator addresses indicating whether said entered data is present in said plurality of addresses; and
means for selecting a locating address from among the addresses of said plurality of addresses.

8. Computer program product stored on a computer readable carrier, wherein the product comprises program code instructions to execute a method of composing an address for locating a resource on the Internet when it is executed on a computer, wherein the method comprises a phase of conversion of a piece of data into a locator address comprising:
entry by a user, into a browser software, of a piece of data representing a locator address;
comparing said piece of entered data with at least certain addresses of a plurality of preliminarily validated locator addresses indicating whether said entered data is present in said plurality of addresses; and
selecting a locator address from among the addresses of said plurality of addresses.
